(19) United States
(12) Patent Application Publication
(10) Pub. No.: US 2003/0126593 A1
(43) Pub. Date: Jul. 3, 2003

(54) Interactive physiological monitoring system

(76) Inventor: James R. Mault, Evergreen, CO (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/275,350

(22) PCT Filed: May 4, 2001
(86) PCT No.: PCT/US01/40678

(51) Int. Cl. H04N 7/16; H04H 9/00

(52) U.S. Cl. 725/10; 725/9

(57) ABSTRACT

Systems and methods relating to the physiological monitoring of a subject are disclosed. A system embodiment for physiological monitoring of a person comprises a monitor module, which monitors a physiological parameter of the person, the module having a wireless transmitter such as a Bluetooth transmitter. The system further comprises an interactive television system, which receives a signal from a remote control unit, such as an IR or other wireless transmission, wherein the received signal is used to modify visual presentations on a display of the interactive television system, such as changing channel, providing numerical data in response to presented menus, selecting from presented menus using navigation keys, and the like. The system further comprises a portable computing device, adapted to receive physiological data transmitted by the monitor module and to store the physiological data in a memory, and which is further adapted to function as the remote control unit of the interactive TV, so as to transmit stored physiological data to the digital interactive television, and to provide a signal for remote control and interaction with the interactive TV.

### FIELD OF THE INVENTION

The invention relates to the monitoring of diet, physical activity level, and physiological parameters of a person, wherein the person may view monitored parameters and feedback on a digital interactive television.

### BACKGROUND OF THE INVENTION

There is great demand for health monitoring systems. Conventional physiological monitors allow instantaneous values of physiological parameters, such as heart rate, to be viewed. However, it would be very useful to review physiological parameters over a time period using a device having enhanced audio-visual display capabilities.

### SUMMARY OF THE INVENTION

The person is in possession of a portable electronic device, which is capable of monitoring a physiological parameter of the person. This device may comprise a portable computer, personal digital assistant, wireless phone, body-mounted physiological monitor, or custom built device. For convenience, the device will be referred to as a monitor module. However, this invention is not limited by that choice of name, as it can be used to monitor a variety of parameters related to the person, including the physical activity level of the person, body weight, caloric intake, blood sugar levels, metabolic processes, caloric expenditure, and other physiological parameters. The monitor module has the ability to receive and transmit data, e.g. by radio, IR, optical, other electromagnetic radiation, or through physical connection(s) such as wires, memory module exchange, etc., or by some combination of methods. The preferred embodiment is for the monitor module to transmit and possibly also to receive data through a wireless method such as the Bluetooth System. In the preferred embodiment, the monitor module has a memory for data storage capability.

The monitor module receives data from one or more sensors. These sensors can include accelerometers for measuring physical activity, medical sensors of various kinds carried by the person, other medical equipment, weight measuring devices (scales), etc. These data are received and (preferably) stored by the monitor module. The monitor module may have information display capabilities, and means to enter data by hand by the person. In the preferred embodiment, the monitor module is designed for convenient and lightweight carriage by the person, so display and data entry capabilities may be limited. Sensors may be built into the monitor module, for example an accelerometer for physical activity measurements. Other sensors may be in very close proximity to the monitor module; for example, a blood glucose sensor could be implanted into the person and be powered by, for example, radiation (e.g. light waves, radio waves) emitted by the monitor module. The advantage of this system configuration is that the sensors need only transmit data as far as the monitor module, which will typically be only a few feet away. This range is within the range of the lowest power Bluetooth transmission chips currently sold by Ericsson and other licensees of the technology. Hence the sensors have lower power requirements than if they needed to communicate with e.g. a more distant computer. Other data communication methods (e.g. IR, wire connections) between the monitor module and the sensor(s) could also be used.

Sensors carried by the person include those which respond to the following effects, events, or parameters: body temperature, blood component concentrations (e.g. glucose, alcohol, cholesterol), blood pressure, respiration components (e.g. oxygen, carbon dioxide, volatile organic compounds, alcohol, isotopically labeled compounds, etc.), physical activity, heart beat, pregnancy contractions, developing baby status, brain waves, sleep apnea, physiological parameters of other kinds, physical location, environmental factors (e.g. external temperature, radiation exposure, harmful substance exposure, etc.), and/or any other device designed to respond to a desired parameter. Sensors can also be placed on other nearby persons, e.g. babies. Data from such sensors is monitored continuously and/or at time intervals. The time intervals can be fixed or can change with changing circumstances. The monitor module can also be used to collect data from other devices that the person may interact with, e.g. an indirect calorimeter (e.g. comprising an oxygen sensor and respiration flow meter) which may transmit metabolic rate data to the monitor module. The monitor module can also collect data from any device providing physiological, dietary, or lifestyle information, e.g. medical equipment, exercise machines, vending machines, bar code readers, etc.

In a preferred embodiment, the person sits in front of (or otherwise interacts with) a device with display capabilities. This device can be a television, computer, device for displaying Internet content, satellite receiver, personal data assistant, personal computer, satellite or cable box, other entertainment device, etc. In the preferred embodiment, this device is a digital interactive television. The interactive television (interactive TV) can be a unitary device, or a combination of devices, e.g. a television connected to external communication devices, or having a set-top box with data communications capabilities. The interactive television can also incorporate the functionality of a computer. The interactive television is connected to a computer network, such as the Internet, using for example optical fibers, wires (cables, etc.), wireless communication, or other electrical, or electromagnetic methods. This disclosure will henceforth use the term interactive television (or interactive TV), but this is non-limiting, as other devices can be used. The monitor module can also communicate with the Internet directly through a wireless link, which would be useful e.g. in an emergency situation.

The data collected by the monitor module is transmitted to the interactive TV, using wireless communication, IR, optical, or other electromagnetic or electrical methods. In the preferred embodiment, the transmission uses Bluetooth protocol wireless interaction. Data transfer between the monitor module and the interactive TV is person initiated (e.g. a button on the monitor module is pressed) and/or an automatic process (e.g. the monitor module may automatically send out signals detected by the interactive TV or vice versa). The interactive TV can have a separate remote control which is used to control data transfer, or the monitor module (or another portable electronic device, e.g. a PDA) can act as a remote control for the interactive TV.

Data collected by the monitor module from various sensors are transmitted to the interactive TV. In a preferred embodiment, the interactive TV is connected to a computer network, e.g. the Internet. Data can be sent from the interactive TV over the Internet to a remote computer (or computers), for data analysis, physician review, expert system analysis, display on a remote device, display on a web page viewable by the person and/or other authorized persons, etc. The interactive TV can provide some or all of the computer power for data analysis. Data may be encoded to protect the privacy of the person.

The interactive TV is used to provide feedback to the person. The interactive TV may, for example, provide messages of support, encouragement, concern, etc.; suggestions for person actions; options for ordering products or services; graphical display of measured parameters (as collected by the monitor module) or parameters derived from the measured parameters; medical advice; referral for physician services; weight-loss advice; dietary advice; display of trends suggested by the data; future predictions; warnings; display of information derived from data collected by the monitor module in conjunction with other sources of data; etc. Information is presented by any method supported by the interactive TV or by a device connected to (i.e. in communication with) the interactive TV, for example graphical, text, audio, three-dimensional, or video forms of display.

Further information can be collected from the person and/or from other devices and the feedback enhanced or refined. For example, the person can supply additional information using a TV remote control (e.g. via a menu of options), by spoken voice, by gesticulations, or using a personal digital assistant (PDA) if the PDA is not acting as the monitor module.

Feedback can also be provided from a web site on the Internet displaying information related to the person. The interactive nature of the dialog between person and interactive TV might include simple text menus with selectable options, or might be a sophisticated scheme with a simulated or video generated figure asking questions, with voice recognition software used to process the response. A physician, dietary councilor, other authorized person, or computer expert system can monitor the collected data by accessing a web site or database.

A physiological monitoring system for a person can comprise: at least one sensor device capable of data transmission disposed on the person; a data storage device capable of receiving and collecting data disposed on the person; and a display unit capable of receiving data, whereby physiological data is collected by the sensor device, the data being transmitted to and stored in the data storage device and the data is then transmitted to and displayed on the display unit. A physiological monitoring system for a person can also comprise an electronic device having display means and a memory card interface and at least one physiological monitors having a memory card interface, whereby data can be transferred from the physiological monitor to the electronic device with display means by transfer of a memory card. The system can further comprise memory cards having wireless communication means, such as Bluetooth communication capabilities.

A further system embodiment for physiological monitoring of a person comprises a monitor module, which monitors a physiological parameter of the person, the module having a wireless transmitter such as a Bluetooth transmitter. The system further comprises an interactive television system, which receives a signal from a remote control unit, such as an IR or other wireless transmission, wherein the received signal is used to modify visual presentations on a display of the interactive television system, such as changing channel, providing numerical data in response to presented menus, selecting from presented menus using navigation keys, and the like. The system further comprises a portable computing device, adapted to receive physiological data transmitted by the monitor module and to store the physiological data in a memory, and which is further adapted to function as the remote control unit of the interactive TV, so as to transmit stored physiological data to the digital interactive television, and to provide a signal for remote control and interaction with the interactive TV.

A system embodiment to assist a person to monitor a physiological parameter can comprise: a monitor module comprising a processor, a memory, a data transmitter, and a transducer providing physiological data correlated with the physiological parameter; an interactive television system, having a display, a receiver adapted to receive physiological data, and a communications link to a communications network; a remote computer system, having a communications link to the communications network; a software application program on the interactive television, adapted to process physiological data received by the receiver, and to provide a visual presentation of the physiological data on the display, to transmit the physiological data over the communications network to the remote computer system, to receive feedback data from the remote computer system, and to provide a visual presentation of the feedback on the display; and a software application program on the remote computer system, adapted to generate the feedback based on the physiological data received by the remote computer system. A remote control unit can be adapted to transmit response data to the interactive television based on the visual display of the feedback on the display.

A method of viewing the time-dependence of a physiological parameter can comprise: carrying a monitor module, wherein the monitor module is adapted to measure a value of the physiological parameter and to store the value in a memory of the monitor module, the monitor module further comprising a data transmitter; transferring data from the monitor module to an interactive television, the interactive television having a display, a data receiver, and a communications link to a remote computer system; and viewing the time-dependence of the physiological parameter on the display of the interactive television. Data can be transferred data from the monitor module to the interactive television using wireless transmission of data from the data transmitter of the memory module to the data receiver of the interactive television. The step of transferring data from the monitor module to the interactive television can also comprise the transmission of the data from the monitor module to a portable computing device, and the transmission of the data from the portable computing device to the interactive television, or the transmission of the data from the monitor module to a remote control, and the transmission of the data from the remote control to the interactive television.

U.S. provisional applications Serial No. 60/201,902, filed May 4, 2000, No. 60/209,921, filed Jun. 7, 2000), and U.S. patent application Ser. No. 09/669,125, filed Sep. 25, 2000, and Ser. No. 09/821,417, filed Mar. 29, 2001 are incorporated herein by reference.

### BRIEF DESCRIPTION OF THE DRAWINGS

FIG. 1 shows a system according to the present invention, comprising a monitor module, a portable computing device, and an interactive television system;

FIG. 2 shows a system according to the present invention, comprising a monitor module, a portable computing device, an interactive television system, and a remote computer system connected to a communications network;

FIG. 3 shows a person carrying a monitor module;

FIG. 4 shows a person interacting with an interactive television system, according to a system embodiment of the present invention.

FIG. 5 shows a schematic of a possible embodiment of a monitor module;

FIG. 6 shows a schematic of a possible embodiment of an interactive television;

FIG. 7 shows a schematic of a possible embodiment of an improved remote control;

FIG. 8 shows a flow chart illustrating a method according to the present invention;

### DETAILED DESCRIPTION OF THE INVENTION

Physiological Monitoring System

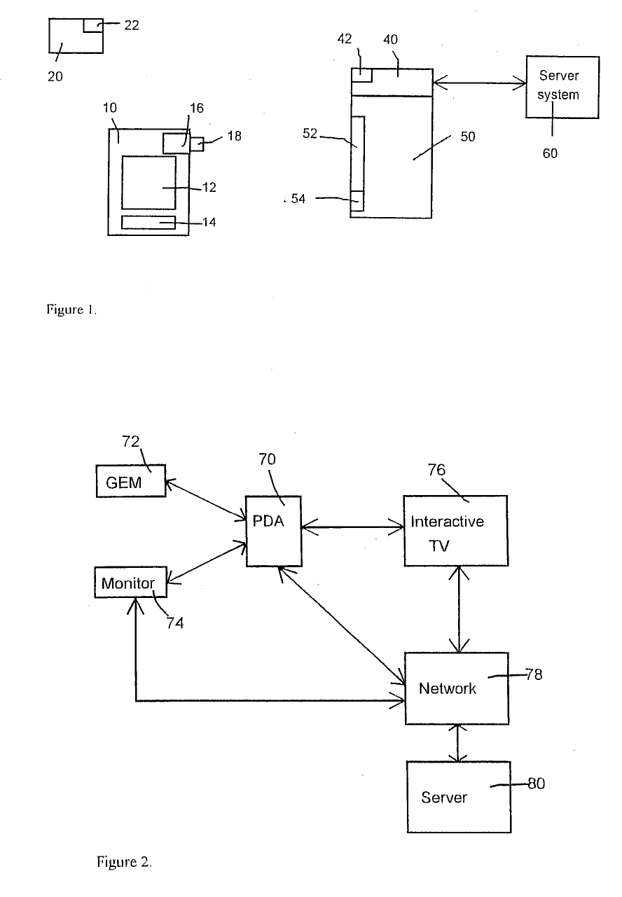

In FIG. 1, device 10 is a portable electronic device having display 12, a data entry mechanism 14, and a memory module interface 16 (such as a slot) for receiving a memory module 18 (such as a memory card, memory stick, disk, or other memory element). Data can be read from and/or written to the memory module 18 when the memory module is in the interface 16. Device 20 is a monitor module, having a memory module interface 22. The device 20 records physiological parameters of the person to a memory module placed in interface 22, and this data can be transferred from the monitor module 20 to the portable electronic device 10 by transferring a memory module from, the interface 22 to the interface 16 of the device 10. As shown in FIG. 1, the memory module is interfaced with device 10. Device 50 is an electronic device with audio-visual presentation means (display 52, speaker(s) 54), such as a television. Device 40 is a set-top communications device such as a satellite box, cable box, wireless box, web-TV box, etc. Clearly the physical location of 40 relative to 50 is not critical, the configuration could be for an under-set box. Also, devices 40 and 50 may be combined into a unitary device with the functionality of a TV combined with additional communication means, and possibly also with computing means. Communications device 40 has a memory card reader 42, which can receive, read data from, and write data to a memory card such as 18. Device 40 is connected to a remote computer system (server system) 60 using a communications link or network such as the Internet, shown as a double headed arrow in FIG. 1.

Device 10 may be a portable computer, personal digital assistant (PDA), wireless phone, or other portable electronic device. Preferably, device 10 is a PDA or a Health Buddy (supplied by Health Hero, CA). The memory module 18 can be a non-volatile memory module, smart card, flash card, memory stick, or similar, such as manufactured by Sony, San Disk, and others. The data entry mechanism can be one or more buttons, a keyboard, stylus, tracking device, voice recognition system, touch pad, rolling dial, and the like.

Monitoring device or monitor module 20 is preferably carried by a person. In other embodiments, the person interacts at intervals with the monitor module. Physiological processes or parameters are monitored by the monitor module, which can include: components of respiration (e.g. oxygen consumption for metabolic rate calculation, carbon dioxide exhalation, presence of volatile organics in the breath), respiration frequency (e.g. for infant monitoring, sleep apnea monitoring, etc.), blood analysis (e.g., for levels of oxygen, carbon dioxide, glucose, ketones, aldehydes, cholesterol, lipids, red cell count, white cell count, etc.), blood pressure, skin conductivity, lung function, respiratory flow volume, heart beat (e.g. electrocardiograms, digitized acoustic recordings, etc.), pulse rate, brain activity and processes, physical activity levels, body temperature, etc. Other physiological parameters which can be monitored are described in co-pending U.S. Provisional App. 60/228,680 (filed Aug. 29, 2000), incorporated herein by reference. The monitoring device can also be an activity sensor, e.g. accelerometer or pedometer. The physical location of the person may also be monitored using a global positioning system, and environmental factors such as temperature, radiation exposure, chemical exposure, etc. may be monitored.

Monitor module 20 can be carried by the person more or less continuously. For example, if a the monitor module is a physical activity sensor, it can be attached to the body of the person using a strap, clip, adhesive pad, or other mechanism. Monitor module 20 can also be a physiological monitoring device used temporarily by a person, such as medical equipment or other devices that it would not be necessary to a person to carry around all day. The physiological monitoring system may use a plurality of monitor modules such as 20.

A memory card provides a convenient method of transferring a large amount of data from a physiological monitoring system to a computer, interactive TV, set-top can then be transmitted to a remote computer system, for viewing e.g. as a web page. Data transferred might include one or more time-dependent physiological parameters, spectral data from analytical equipment, recordings of physiological processes (e.g. heartbeats) as digitized waveform files (e.g. from audio, electrical, etc. measurements), imaging data (ultrasonic, optical, IR, etc.), etc. The memory card is small, but has a large data storage capacity. The memory card is a valuable part of an improved physiological system, as it is useful for recording of a large array physiological parameters throughout the day, then rapidly transferring them to a computer system for analysis, or a device with display means for review.

System for Weight Control

The following example illustrates the use of a system according to the present invention in a weight control program. FIG. 2 shows a portable electronic device 70, such as device 20 in FIG. 1, preferably a portable computer or PDA, used in the system. Device 72 is an indirect calorimeter for measuring the metabolic rate of a person, preferably the Gas Exchange Monitor (GEM) recently developed by James R. Mault M.D. and others, or other indirect calorimeter such as described in U.S. Pat. Nos. 6,135,107, 5,836,300, 5,179,958, 5,178,155, 5,038,792, and 4,917,108, incorporated herein by reference. Monitor module 74 is a physical activity sensor comprising a body-mounted accelerometer. In other embodiments, monitor module 74 can comprise one or more physiological monitors, such as discussed above in relation to the monitor module 20 of FIG. 1. System 76 is an interactive television system, such as the combination of devices 40 and 50 discussed relative to FIG. 1. In other embodiments, system 76 can be computer system. Server 80 is a remote computer system, and communications network 78 is preferably the Internet.

The double-headed arrows represents communication links between the elements of the system, using wireless communication, IR, wires, optical links, transfer of memory modules, manual reading/data entry, ultrasound links, or other electric, electromagnetic, or radiation methods. Preferably, the system uses Bluetooth protocol wireless communication, IR, or memory cards to transfer data between the elements.

A person carries the PDA 70 and monitor module 74. The person measures their resting metabolism every e.g. week using the Gas Exchange Monitor (GEM) 72, an indirect calorimeter invented by James R. Mault. Metabolic data is transferred to the PDA 70. The monitor module 74 transmits physical activity data using the Bluetooth wireless protocol to the PDA 70. The PDA 70 is also used to record the caloric intake of the person, for example using a diet log software program such as described in U.S. Pat. Nos. 5,704,350 and 4,891,756 to Williams, incorporated herein by reference, or other menu-based entry systems, bar-code scanners, and the like. The monitor can also transmit data to the remote computer using e.g. a wireless Internet connection.

The PDA can be used to transmit data to the interactive television 76, and the PDA 70 and the interactive television 76 can also communicate with the remote computer system (server system) 80 via a communications network 78, such as the Internet.

A physician or computer expert system can send motivational video messages to the person, using remote computer system 80, or using another device connected to network 80, which can be received by interactive TV 76. The person can view the messages on interactive TV 76, or download the video messages to a memory card, for viewing on the PDA or other device at any time.

Weight Loss Methods.

The person carries a monitor module on their person which has Bluetooth data transmission and reception capabilities. The person weighs themselves, and the weight data is transmitted from the scales to the monitor module. Accelerometers monitor the physical activity level of the person, and transmit data to the monitor module. The person monitors their caloric intake, recording the data in the monitor module, or into another device, such as a personal digital assistant (PDA).

At some time during the day, the person sits in front of an interactive television. The monitor module transmits data to the interactive TV and initiates a dialog. The weight and activity level of the person are transmitted from the monitor module to the interactive TV. The caloric intake of the person is also transmitted to the interactive TV.

If weight has been gained by the person, the interactive TV responds with suggestions for diet or lifestyle adjustments. If a weight gain resulted from the person's caloric intake being above that necessary for the person's level of activity, the response to the person will suggest a reasonable combination of increased activity and/or reduced caloric intake. The rest metabolic rate and the effects of physical activity on metabolic rate, key parameters often neglected in weight loss schemes, are measured using an indirect calorimeter at the beginning of the weight loss program. Measurement of these parameters is repeated as necessary, depending on the time duration of the weight loss programs. Knowledge of metabolic rate, activity level, and caloric intake allow the feedback to be of improved accuracy, because the origin of the weight gain will be apparent from the measured data. If more activity is required, a series of exercises will be suggested. Options might include an exercise video displayed on the interactive TV.

If weight has been maintained or lost by the person, the interactive TV responds with encouraging messages. Progress towards the person's weight loss goal is displayed graphically on request. Other trends, such as activity and diet, are also presented in this way if the person requests. Preferably, the interactive TV is a device the person uses frequently for audio-visual entertainment. Many people spend several hours each day sitting in front of such a device, and so it can be conveniently integrated into a weight loss program.

As part of a weight loss program, a person can carry a personal digital assistant which also functions as the monitor module. The person enters the food eaten into the PDA, which calculates caloric values. The PDA also receives activity data from accelerometers carried by the person and weight information from scales, preferably by wireless transmission or by IR transmission. The PDA is used to send information to the interactive TV, preferably by wireless transmission or by IR transmission. This information comprises data received from sensors carried by the person, along with dietary information entered by the person. Feedback is provided by the interactive TV.

A business model for a weight loss or medical monitoring program can be as follows. A person is provided with a monitor module and any required sensors by a company. The person preferably uses their own television as a display device, but communication equipment for communication with the PDA or Internet is provided by the company. The company also sets up a web site which is highly personalized to the person, and which serves as an access point for data. The company provides expert advice and feedback to the person. The person pays a fee to the company for goods and services rendered.

Medical Monitoring Scheme for a Person

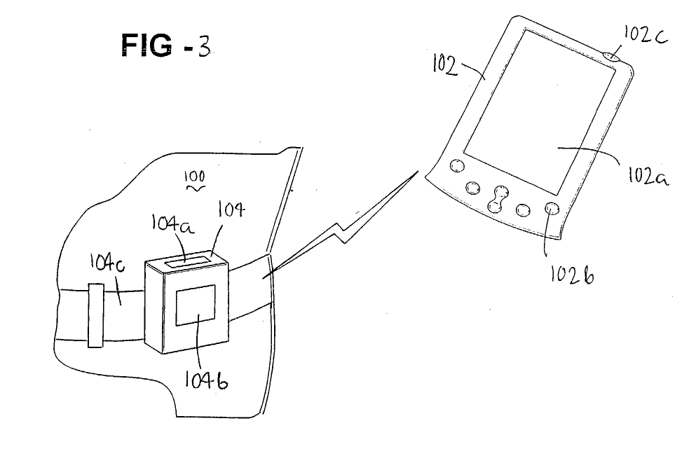

FIG. 3 illustrates a blood glucose concentration monitor module 104 mounted close to the skin of a person 100. The monitor module 104 has low power data transmission capabilities, using Bluetooth wireless communication means, which enables data to be sent to a data storage and analysis device 102, in this example a portable computing device having display 102a, data input mechanism 102b, and IR transmitter/receiver 102c. The sensor 102 is supported around the body (or wrist) of the person using strap 104c. The sensor 104 can also monitor the physical activity level of the person using a built in accelerometer. The sensor 104 is shown having a memory module interface 104a, display 104b, and strap 104c. Blood glucose is measured as a function of time, for example using interstitial fluid analysis methods and systems discussed in co-pending U.S. Provisional Application No. 60/257,138 (filed Dec. 20, 2000), incorporated herein by reference, and the data is stored in a memory of the monitor module. The person also records the time and nature of food eaten, by any convenient method. If, at any part of the day, glucose levels move outside given safe limits, the monitor module or portable computer can make a bleeping noise using an audio generator, or vibrate, to alert the person. At some convenient time, the person sits in front of an interactive television and transmits the glucose data stored in the monitor module to an interactive TV for review of monitored data.

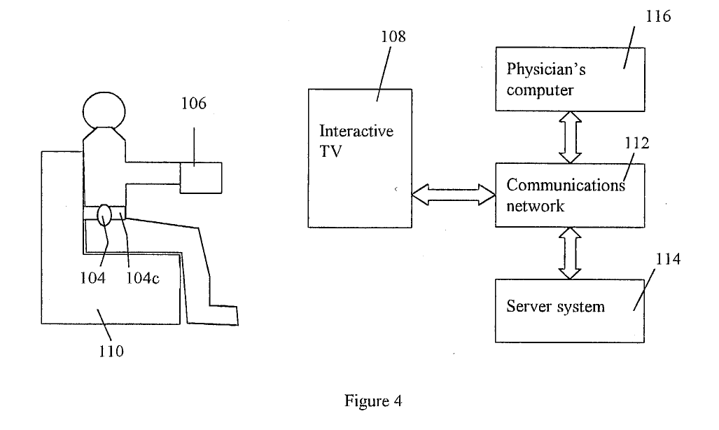

FIG. 4 shows a person sitting on chair 110, with the monitor sensor 104 conveniently mounted around the waist region on the strap 104c. The person operates a remote control 106 to control the interactive television 108. The portable computer 102 of FIG. 3 can be used as the remote control, but a separate device can also be used. The interactive television is connected to a communications network 112, such as the Internet. The interactive TV 108 can be used to display glucose levels from a preceding time period, or in real time if of interest. The person is prompted by the interactive television to enter the day's dietary information. The interactive TV can then displays the day's blood glucose fluctuations (and/or other physiological parameters) graphically, and can correlate the graph with meals eaten. Dietary advice can then displayed to the person, so as to avoid future unhealthy blood glucose excursions. Information can be transmitted over the communications network 112 to a remote computer, such as server system 114, which can then be accessed by any authorized person, such as the person or a physician using physician's computer 116. The person uses the remote control 106 to interact with the television, using a data entry mechanism on the remote control.

Systems according to the present invention are useful for monitoring patients in hospital and people in convalescent homes. For example, a doctor can approach a patient, initiate transfer of physiological data to an interactive television system over the patient's bed, and view the data. The patient can also engage in self-monitoring, or a remote computer system can provide monitoring software which alerts a medical professional if a measured parameter goes out of range. A physician or other medical professional can access the monitored data, and provide feedback by any convenient communication channel.

Remote Control

The remote control unit can be used to change the channels and volume of interactive TV through a set-top box having remote control sensor, such as an IR receiver or wireless receiver. The remote control sensor can be a conventional IR sensor which receives and analyzes transmissions from the remote control. Data monitored by physiological sensors can be transmitted to the remote control unit using low powered wireless transmitters. The data can then be stored in a memory of the remote control, and can then be transmitted to the interactive television by the remote control.

Monitor Module

A monitor module is preferably carried unobtrusively by the person. For example a monitor module can be supported by a clip or adhesive layer, as described in co-pending U.S. Prov. App. 60/225,454 (filed Aug. 15, 2000), incorporated herein by reference, or can be a strap mounted device such as a wristwatch, or a belt mounted device, for example supported within the small of the back, having a rounded or disk shape. The housing of the monitor module can contain on or more transducers providing an electrical signal correlated with physiological parameters, such as accelerometers, blood analysis systems (for example, using near-IR spectroscopy), interstitial fluid analysis systems, and the like.

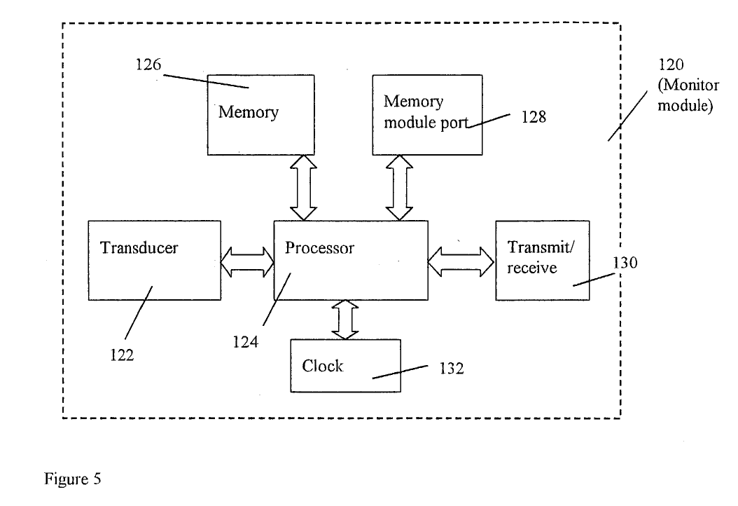

FIG. 5 shows a schematic of a possible embodiment of a monitor module, comprising a transducer 122, providing an electrical signal correlated with a physiological parameter such as physical activity, body temperature, blood component concentration, and the like, a processor 124, a clock 132, a transceiver 130, a memory module port 128, and a memory 126. The transducer may be a thermistor, accelerometer, blood component (analyte) sensor, or other device providing a signal correlated with a physiological parameter, bodily function, or subject status. Animals and non-living subjects (such as computer operation status) can also be monitored. Signals correlated with ambient or environmental conditions can also be monitored.

Data Transfer to Interactive TV

A monitor module having wireless transmission capabilities can transmit data directly to an interactive television. The monitor module can have Bluetooth, IEEE 802.11, or IR transmission capabilities. Elements of systems described herein can form a local wireless network, for example using Bluetooth or IEEE 802.11 protocols.

A monitor module can be in the form of a memory stick, such as described in detail in co-pending U.S. provisional application Serial No. 60/225,454, filed Aug. 15, 2000. In this case, the monitor module can be placed into a memory module interface of a portable electronic device (such as a PDA or a remote control), of an interactive television, or another device in communication with the interactive television, such as a cell phone, pager, or device linked to a communications network to which the interactive television is linked.

The monitor module can have a memory module interface, such as a slot, and can be provided with a removable memory module, which can be used to transfer data to the interactive television using methods discussed in the previous paragraph. For example, a memory stick containing stored monitored values of a physiological parameter can be placed into a memory module interface of a suitable adapted television remote control. The remote control can then be used to transmit the data to the interactive television, for example using an IR link. A PDA or other portable electronic device can be used to both transmit data to the interactive TV, for analysis of monitored data, and to act as a remote control.

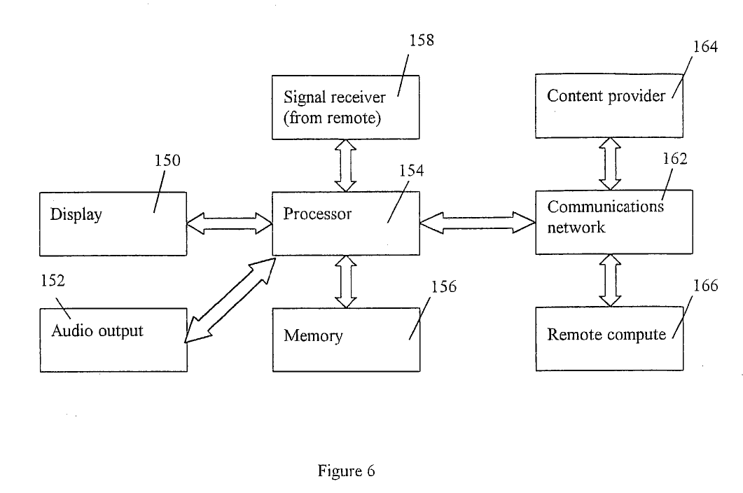

FIG. 6 shows a schematic of a possible embodiment of an interactive television, having a display 150, speaker(s) 152, a processor 154, a memory 156, signal receiver (adapted to receive data from a remote computer or equivalent device) 158, and a communications link to a communications network 162, providing access to a content provider 164 (a source of programs, other entertainment, health programming, and the like), and a remote computer 166 providing access to health analysis software, physiological and health databases, software-generated feedback, and the like.

A person viewing the interactive TV can press a button mounted on the housing of the monitor module to initiate data transmission to the interactive TV, remote control, portable computer, or other device. The monitor module can be interfaced (plugged into) or connected by cable or other link to a remote control unit, allowing the remote control unit to receive monitored physiological data.

A remote control unit can be used to allow the person to interact with the interactive TV, for example by responding to questions generated by a remote computer system or local algorithm, to add or modify other data, such as a diet log, and to transfer data to the interactive TV. An IR or other wireless signal (such as radio or ultrasound) is transmitted by the remote control to a signal receiver on the interactive TV.

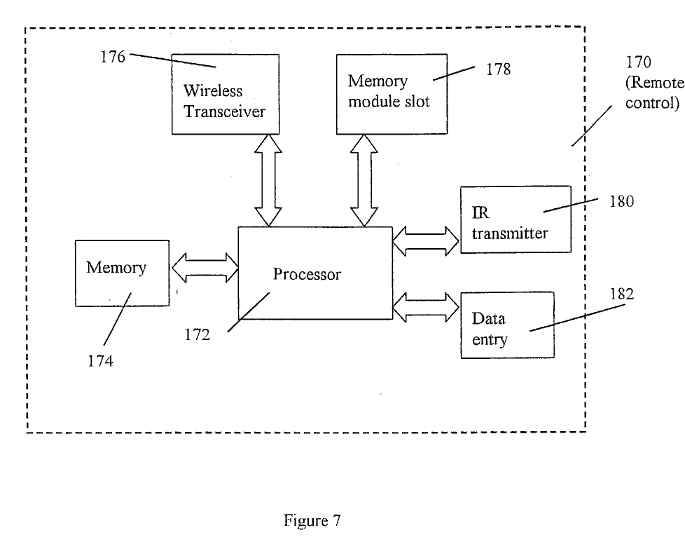

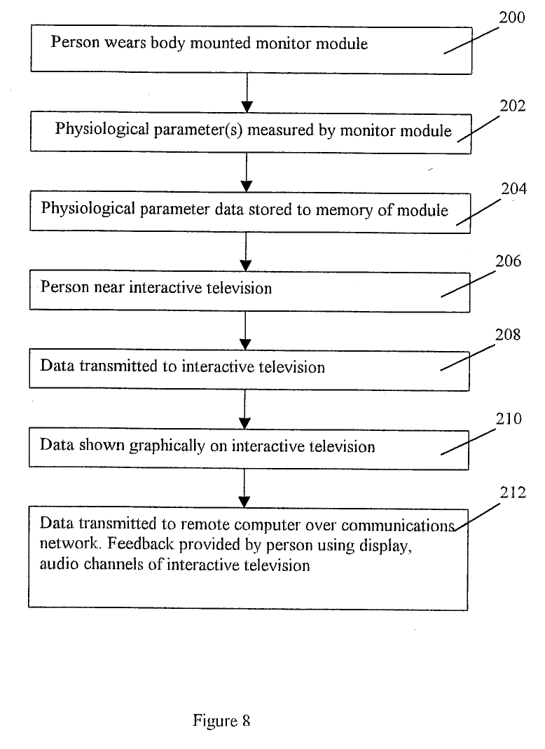

FIG. 7 shows a schematic of an improved remote control unit shown generally at 170, comprising a memory 174, wireless transceiver 176, memory module slot 178, IR transmitter (or transceiver) 180, data entry mechanism 182 (such as a keypad, voice recognition system, stylus entry, touch pad, roller, or the like), and a processor 172.

FIG. 8 illustrates a flow chart of a method according to the present invention. A person wears a monitor module or other physiological monitoring system (200). The monitor measures a physiological parameter (202). The measured physiological parameter data are stored to a memory (204). The person approaches, sits in front of, or otherwise interacts with an interactive TV (206). Physiological parameter data is transmitted to the interactive TV (208). The data received by the interactive TV is processed so as to be displayed graphically, e.g. in the form of a chart (210). physiological parameter data is transmitted to a remote computer system, which has software which analyzes the data, and provides appropriate feedback to the person, in terms of e.g. excursions from safe limits, average values, appropriate behavior modification, medication requirements, the advisability of contacting a physician, and the like.

Regarding step 208, for example, a person may interface a remote control to the monitor, using a connector or cable. The remote control can then be used to transmit data to the television. The monitor may transmit a signal directly to a suitably adapted signal receiver of the television. The remote control may have a wireless connection to the communications network, allowing data to be transmitted to the remote computer system for analysis, with feedback provided on the display of the television. As required data transfer rates to the remote computer system can be much lower than that required for display of entertainment content, feedback, and the like on the television, pager frequencies, FM sidebands, wireless phone connections, and conventional cable phone lines can be used to transmit physiological data to a remote computer system. For example, a pager can be modified so as to include a physical activity monitor or other physiological sensor, and the pager wireless frequency used to transmit data to a remote computer system. The transmitted data can be analyzed by the remote computer system, then used to generate feedback and analysis which can be viewed on the display of the interactive TV at any convenient time for the person. A portable computing device, such as a Palm PDA with IR transmission module, a pager, a wireless phone, monitor module, or other convenient device, can be used as the television remote control. The PDA can be used to interact with the television, responding to feedback or questions shown on the display. Response data can be transmitted to the television, or over a communications network to the remote computer system generating the feedback.

Monitoring of Cardiac Patient.

The following example illustrates the use of a system according to the present invention to monitor the heart activity of a cardiac patient. The person wears a physiological sensor, which records an electrocardiogram, a digitized audio recording of the heart beat, and other useful physiological parameters such as body temperature. This data is written to a memory card plugged into the physiological monitor. At the end of the day, the patient removes a memory card from the sensor and plugs it into a set-top box on their TV. The recorded data is downloaded from the memory card into the set-top box, then communicated via an Internet connection to a remote computer, for storage in a data structure, or possible viewing by a physician.

If the cardiac data from the patient indicates a serious condition, the physiological monitor transmits data (such as the identity of the patient, the nature of the emergency, and the location of the patient) to a remote computer, preferably using a communications network such as the Internet. The physiological monitor can also transmit data, preferably using Bluetooth wireless protocol, to a portable computer such as a personal digital assistant (PDA) carried by the patient. The PDA uses its display or other means to instruct the patient on a recommended course of action. The cardiac data may show a disturbing trend of a parameter towards the edge of an acceptable range. The PDA may use an expert system to recommend actions (or inaction) to the patient based on the nature of the trends. The physiological monitor and/or the PDA may sound an alarm (e.g. a beeping noise), flash lights, or otherwise warn the patient of the situation.

During a course of treatment or recovery, the patient's physician may want to send instructional information, video-mail (v-mail), etc. to the patient via a communications network (e.g. the Internet; hospital intranet; community intranet; or cable or wireless network). This information may be downloaded onto a memory card, using the memory card slot in the set-top box (or other device, such as a personal computer, connected to the communications network), and then transferred to the PDA or other device for review at any convenient time.

Baby Temperature Monitoring

A monitor module can be placed on the skin of a baby, and can transmit temperature data to a set top box connected to a television. The display of the television can then be used to provide visual monitoring of the baby's temperature. In this embodiment, the monitor module has a housing adapted to contact the skin of the baby, for example by being placed in an ear, a temperature transducer such as a thermistor providing an electrical signal correlated with temperature, an electronic circuit, which can comprise an analog to digital converter and a processor, adapted to generate temperature data from the transducer signal and store it in a memory unit, the memory unit (which can be any convenient medium, and can either by fixed within the monitor module housing or a removable module), and a transmitter (or transceiver) which can be a Bluetooth transceiver module.

Memory Card with Wireless Transceiver

The following example illustrates the use of memory cards with embedded Bluetooth wireless transmission devices. A physiological sensor or monitor, such as described previously in this application, has a memory card slot (or reader) for data writing to (and possibly data reading from) a memory card. The memory card has an embedded Bluetooth wireless transmission device. The physiological monitor measures parameters related to the person carrying it, and writes data to the memory card. The memory card is removed after a certain period of time, and placed into the memory card reader of another electronic device, e.g. a PDA, computer, wireless phone, or interactive television, for review and/or analysis of the data, and possibly transmission of the data to a remote computer system using a communications network such as the Internet. The device may be equipped with a wireless Internet connection, possibly using the Wireless Applications Protocol (WAP) system.

When the memory card is placed into the physiological monitor, the monitor gains the capability of transmitting data using the Bluetooth protocol to other devices equipped with a Bluetooth capability. Hence, the data being collected can be transmitted in real time to another device, such as a computer. The monitor is also able to receive data using the Bluetooth protocol, and hence may receive instructions from other devices, perhaps to increase the sampling frequency of physiological measurements. This allows a device that would otherwise be unable to communicate wirelessly with other devices to become capable of wireless communication. Set Top Box

The interactive TV system can comprise a set top box, adapted to receive physiological data from a monitor module, remote control, wireless phone, pager, or other device, and to communicate with a remote computer system using a communications network. However, the functionality of this set-top box can be incorporated into a unitary device.

Other embodiments of the invention will be clear to those skilled in the art. Having described my invention, I claim:

1. A system for physiological monitoring of a person, comprising:
a monitor module, adapted to monitor a physiological parameter of the person, having a wireless transmitter;
an interactive television system, adapted to receive a control signal from a remote control unit; and
a portable computing device, adapted to receive physiological data transmitted by the monitor module and to store the physiological data in a memory, and further adapted to function as the remote control unit, so as to transmit stored physiological data to the interactive television.

2. A system to assist a person to monitor a physiological parameter, comprising:
a monitor module comprising a processor, a memory, a data transmitter, and a transducer providing physiological data correlated with the physiological parameter;
an interactive television receiver, having a display, a data receiver adapted to receive physiological data, and a first communications link to a communications network;
a remote computer system, having a second communications link to the communications network;
a software application program on the interactive television receiver, adapted to process physiological data received by the data receiver, and to provide a visual presentation of the physiological data on the display, to transmit the physiological data over the communications network to the remote computer system, to receive feedback data from the remote computer system, and to provide a visual presentation of the feedback on the display; and
a software application program on the remote computer system, adapted to generate the feedback based on the physiological data received by the remote computer system.

3. The system of claim 2, further comprising a remote control unit adapted to transmit response data to the interactive television based on the visual display of the feedback on the display.

4. A method of viewing the time-dependence of a physiological parameter of a person, comprising:
supporting a monitor module on the person, the monitor module adapted to measure values of the physiological parameter and to store the values in a memory of the monitor module, the monitor module further comprising a data transmitter;
transferring data from the monitor module to an interactive television, the interactive television having a display, a data receiver, and a communications link to a remote computer system, wherein the data includes the values of the physiological parameter; and
viewing the time-dependence of the physiological parameter on the display of the interactive television.

5. The method of claim 4, wherein the step of transferring data from the monitor module to the interactive television comprises the wireless transmission of data from the data transmitter of the memory module to the data receiver of the interactive television.

6. The method of claim 4, wherein the step of transferring data from the monitor module to the interactive television comprises the transmission of the data from the monitor module to a portable computing device, and the transmission of the data from the portable computing device to the interactive television.

7. The method of claim 4, wherein the step of transferring data from the monitor module to the interactive television comprises the transmission of the data from the monitor module to a remote control, and the transmission of the data from the remote control to the interactive television.
